(19) United States
(12) Patent Application Publication
(10) Pub. No.: US 2002/0121494 A1
(43) Pub. Date: Sep. 5, 2002

(54) Safety scale

(76) Inventor: Robert C. Tyer, Orange Park, FL (US)

Correspondence Address: Steven R. Scott, 1228 Salt Road, Webster, NY, 14580, US

(21) Appl. No.: 09/957,287

(22) Filed: Sep. 20, 2001

Related U.S. Application Data
(60) Provisional application No. 60/234,377, filed on Sep. 20, 2000.

(51) Int. Cl. B66C 13/16

(52) U.S. Cl. 212/283

(57) ABSTRACT

A safety scale having(i) an upper section for connection to the rigging of a weight lifting device above the safety scale, which upper section has a lower extension, (ii) a lower section for connection to a weight or the rigging of a weight lifting device below the safety scale, which lower section has an upper extension, with (iii) the aforesaid sections and extensions being disposed in such a manner that the movement of the upper section away from the lower section causes the lower extension to move towards the upper extension; and (iv) force measurement means disposed between the upper extension and the lower extension such that the force, in pounds (or metric measure), exerted can be measured.

### BACKGROUND

This invention relates generally to the field of cranes and other heavy lifting apparatus. More specifically, it relates to safety devices intended to reduce the risk of crane system overloads. In particular, it deals with a novel design for a safety scale for insertion as an intermediate link in the crane rigging between crane and lifting hook or other lifting means. There is, at present, no device known to me as the inventor that serves the purpose of the instant invention in the same manner. There are, of course, industrial scales and other apparatus for weighing heavy items prior to lifting. However, the weighing of items on such scales prior to lifting imposes an extra step and inconvenience that greatly decreases efficiency and is, therefore, generally ignored even where such scales are available. Thus, heavy lifting by mechanical means is generally based on guesswork regarding the weight of the load being hoisted. Often a load may be lifted that exceeds the safety limits of the crane or other lifting device. This may result in the failure of lifting device rigging and/or tackle with potentially disastrous and dangerous results for equipment and workmen who may be in the vicinity.

### SUMMARY AND OBJECTS OF THE INVENTION

It is the object of this invention to eliminate the dangers of lifting device overload by the provision of a simple, rugged, easily manufactured safety scale for interposition in the rigging of a lifting device or crane. Thus, as the lifting device begins to lift the weight in question, the safety scale of this invention is activated. Those supervising the lifting operation can easily observe whether the load exceeds the limit for the equipment prior to lifting the weight from the ground or position where it is at rest. The safety scale produced in accordance with the teachings of this invention is characterized, in general, by (i) an upper section for connection to the rigging of a weight lifting device above the safety scale, which upper section has a lower extension, (ii) a lower section for connection to a weight or the rigging of a weight lifting device below the safety scale, which lower section has an upper extension, with (iii) the aforesaid sections and extensions being disposed in such a manner that the movement of the upper section away from the lower section causes the lower extension to move towards the upper extension; and (iv) force measurement means disposed between the upper extension and the lower extension such that the force, in pounds (or metric measure), exerted can be measured.

### BRIEF DESCRIPTION OF THE DRAWINGS

FIG. 1 provides a first view of a first preferred embodiment of the instant invention.

FIG. 2A provides a frontal exploded view of the upper section of a second preferred embodiment of the instant invention.

FIG. 2B provides a view from above of a portion of the upper section of a second preferred embodiment of the instant invention.

FIG. 3 provides a frontal view of the lower section of a second preferred embodiment of the instant invention.

FIG. 4 provides a side view of the lower section of a second preferred embodiment of the instant invention.

FIG. 5 provides further information regarding pivoting link alternatives.

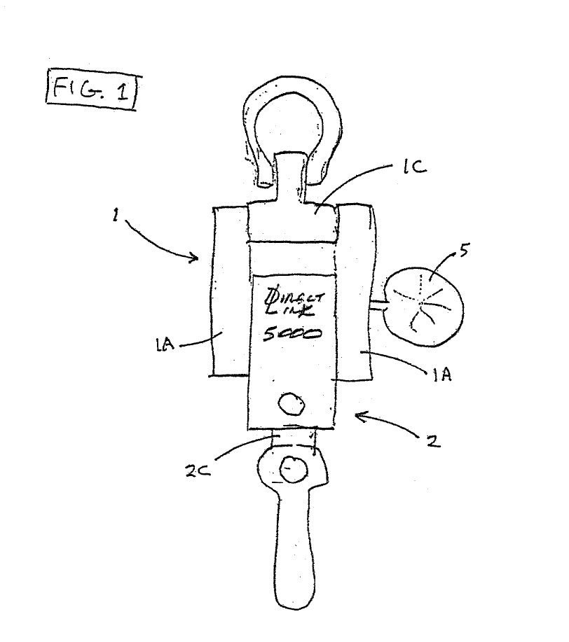

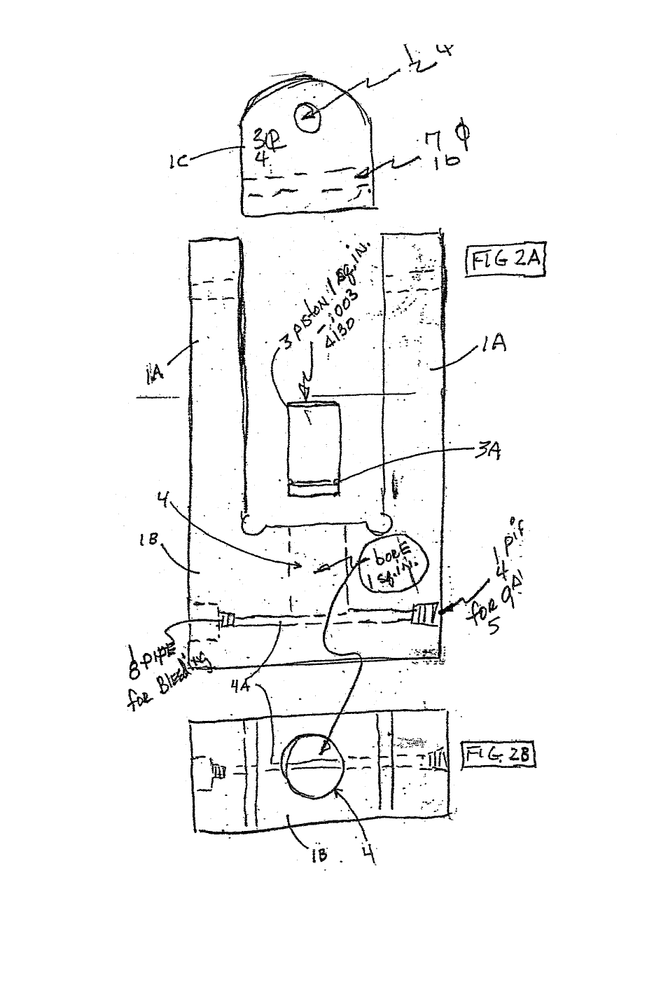

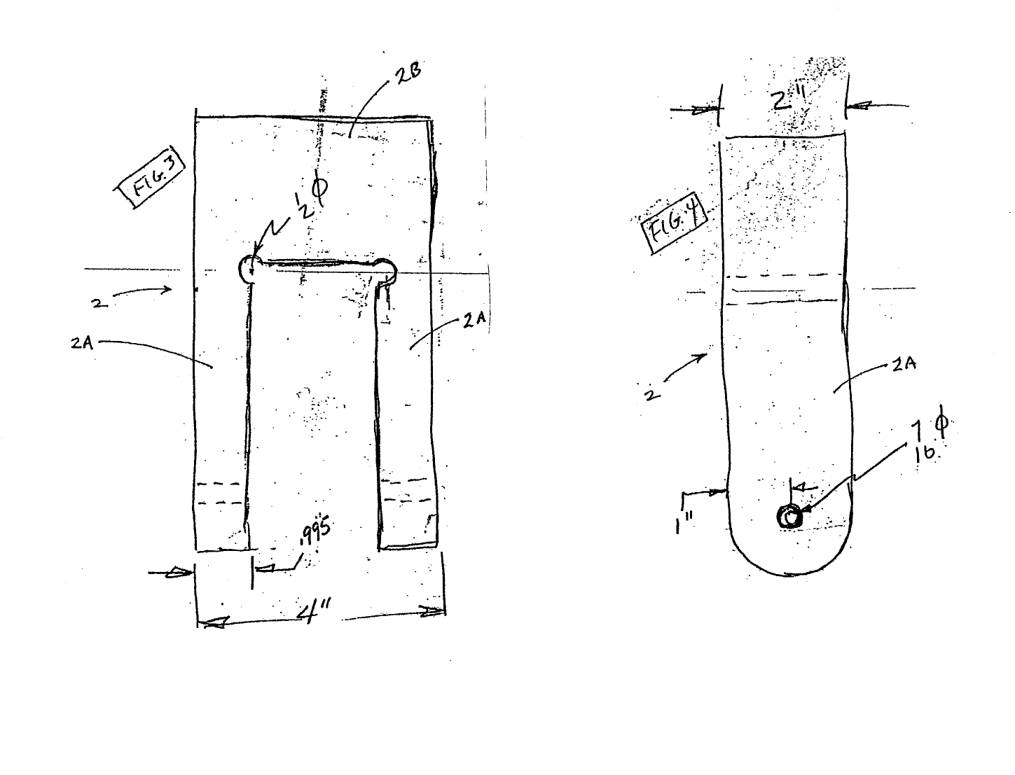

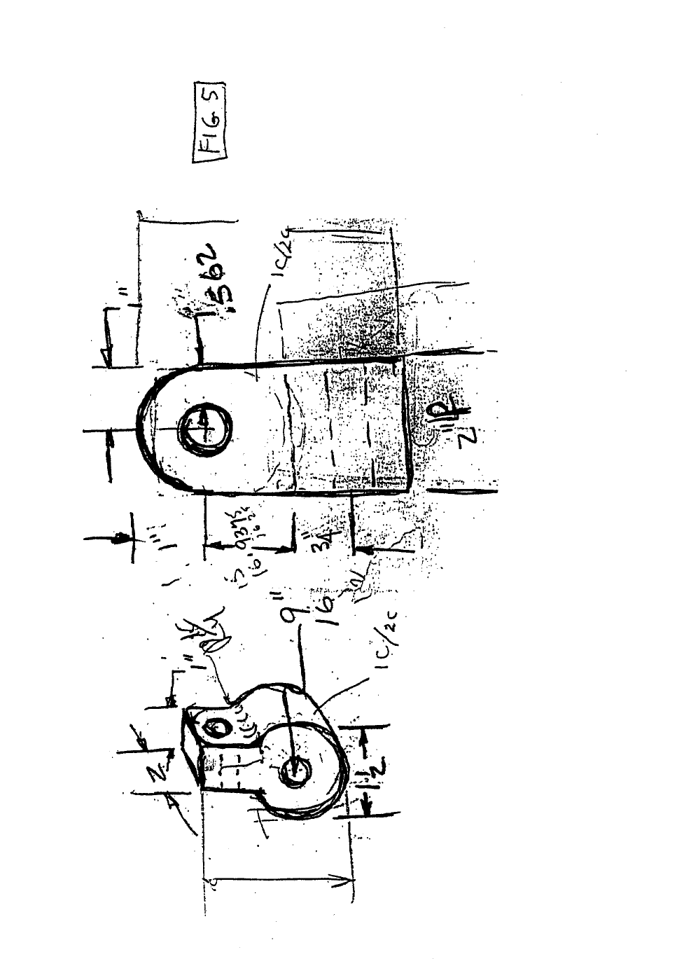

### DETAILED DESCRIPTION OF THE PREFERRED EMBODIMENT

As will be noted from review of the drawing figures, the instant invention features an upper section (denoted generally by arrow 1) with two upper side arms 1A connected by a lower extension 1B so as to form a generally “U” shaped assembly with an upper pivoting link 1C connecting the two upper side arms 1A at the top of upper section 1. Upper pivoting link 1C serves as the means for connection to the rigging of a lifting device or crane above the invention. The lower section (denoted generally by arrow 2) is also characterized by two lower side arms 2A connected by an upper extension 2B so as to form a generally “U” shaped assembly with a lower pivoting link 2C connecting the two lower side arms 2A at the bottom of lower section 2. Lower pivoting link 2C serves as means for connection to the weight beneath the scale or the rigging of the lifting device or crane beneath the invention.

Upper section 1 and lower section 2 are turned at right angles to each other and interlocked so that the upper side of lower extension 1B is proximate to the lower side of upper extension 2B. Further, upper section 1 and lower section 2 and their appurtenant parts are dimensioned such that they are snugly interlocked when placed together. The only movement allowed when they slide together and apart is, therefore, along an axis that is parallel to upper side arms 1A and lower side arms 2A and perpendicular to lower extension 1B and upper extension 2B. Thus, when connected in the rigging of a lifting device intermediate the weight being lifted and the lifting means or crane while the aforesaid weight is being lifted by the lifting means/crane, the upper side of lower extension 1B and the lower side of upper extension 2B are pulled against each other with (and up to) the full force of the weight being lifted. Anything placed between upper extension 2B and lower extension 1B will, therefore, be compressed with a force equal to the weight of the load being lifted. In this situation, the interpositioning of an appropriate force measurement means between upper extension 2B and lower extension 1B will provide a way for measuring the weight of the load being lifted.

As inventor, I have provided means in the form of a piston 3 with sealing O-ring 3A nested in a cylindrical void (denoted by arrow 4) in lower extension 1B. Both the piston 3 and cylindrical void 4 have a cross-sectional area of one square inch. The cylindrical void 4 is filled with an incompressible fluid of the type well known and used in the mechanical arts for, e.g., hydraulic lifts. A separate channel 4A is provided in lower extension 1B which, on one side, leads to means for connection of a hydraulic fluid pressure gauge 5 calibrated for measurement of pressure per square inch. On the other side, it leads to an opening with plug or bleed valve.

To utilize the force measurement means described, piston 3 is inserted in cylindrical void 4 such that a substantial portion extends therefrom. Cylindrical void 4 is filled with incompressible fluid and the aforesaid plug opening or bleed valve is used to assure that there are no bubbles in cylindrical void 4, channel 4A and/or pressure guage 5. At this point, as the pressure used to compress piston 3 is being transferred from lower extension 1B to upper extension 2B via the one square inch area of piston 3, the pressure valve (being calibrated in pounds per square inch) provides an accurate measurement of the weight on the assembly as it is hoisted.

Numerous variations are possible without exceeding the scope of the inventive concept revealed herein. Thus, the aforesaid specification should be interpreted in the broadest manner possible consistent with the intentions expressed therein and yet not so broadly as to infringe or be unpatentable over any existing patent. Further information is provided in Exhibit A, attached with regard to an earlier embodiment and the features and benefits of the device.

I claim:

1. A safety scale, comprising:
(a) an upper section for connection to the rigging of a weight lifting device above the safety scale, which upper section has a lower extension;
(b) a lower section for connection intermediate the upper section and a weight to be lifted, which lower section has an upper extension disposed adjacent the lower extension in such a manner that the movement of the upper section away from the lower section causes the lower extension to move towards the upper extension; and
(c) force measurement apparatus disposed between the upper extension and the lower extension.

2. A safety scale, as described in claim 1, wherein the lower extension and the upper extension are generally horizontal.

3. A safety scale, as described in claim 1, wherein the upper section includes a generally U shaped member, the lower extension forming the bottom of the generally U shaped member.

4. A safety scale, as described in claim 1, wherein the lower section includes a member shaped like an inverted U, the upper extension forming the top of the inverted U shaped member.

5. A safety scale, as described in claim 1, wherein the upper section includes a generally U shaped member, the lower extension forming the bottom of the U shaped member; the lower section includes a member shaped like an inverted U, the upper extension forming the top of the inverted U shaped member; and the U shaped member is interlockingly engaged with the inverted U shaped member such that the bottom of the U shaped member is adjacent the top of the inverted U shaped member.

6. A safety scale, as described in claim 1, wherein the force measurement apparatus includes a generally vertical void in the lower extension.

7. A safety scale, as described in claim 6, wherein the force measurement apparatus includes a piston member disposed and slidable in said generally vertical void.

8. A safety scale, as described in claim 7, wherein the generally vertical void includes an incompressible fluid below said piston member.

9. A safety scale, as described in claim 8, wherein a fluid pressure measurement device is in fluid communication with the incompressible fluid below said piston member.

10. A safety scale, as described in claim 9, wherein the fluid pressure measurement device measures pressure in units of weight per a specified unit of area; and the generally vertical void has a cross-sectional horizontal area, which cross-sectional horizontal area is the same as the specified unit of area.

11. A safety scale, as described in claim 5, wherein the force measurement apparatus includes a generally vertical void in the lower extension.

12. A safety scale, as described in claim 11, wherein the force measurement apparatus includes a piston member disposed and slidable in said generally vertical void.

13. A safety scale, as described in claim 12, wherein the generally vertical void includes an incompressible fluid below said piston member.

14. A safety scale, as described in claim 13, wherein a fluid pressure measurement device is in fluid communication with the incompressible fluid below said piston member.

15. A safety scale, as described in claim 14, wherein the fluid pressure measurement device measures pressure in units of weight per a specified unit of area; and the generally vertical void has a cross-sectional horizontal area, which cross-sectional horizontal area is the same as the specified unit of area.

16. A safety scale, as described in claim 1, wherein the shape of said upper section and said lower section limits their freedom of movement when interlocked such that they are only permitted to slide together and apart on a single linear axis.

17. A safety scale, as described in claim 5,wherein the shape of said upper section and said lower section limits their freedom of movement when interlocked such that they are only permitted to slide together and apart on a single linear axis.

18. A safety scale, as described in claim 10,wherein the shape of said upper section and said lower section limits their freedom of movement when interlocked such that they are only permitted to slide together and apart on a single linear axis.

19. A safety scale, as described in claim 15,wherein the shape of said upper section and said lower section limits their freedom of movement when interlocked such that they are only permitted to slide together and apart on a single linear axis.

20. A safety scale, as described in claim 19, wherein said single linear axis is vertical.
